(19) United States
(12) Patent Application Publication
(10) Pub. No.: US 2024/0335962 A1
(43) Pub. Date: Oct. 10, 2024

(54) ELECTRIC NOSE HAIR SUCTION CLIPPER

(71) Applicant: Weixiang HUANG, Ganzhou (CN)

(72) Inventors: Weixiang HUANG, Ganzhou (CN); Yiwen CHEN, Ganzhou (CN); Shijia CHEN, Ganzhou (CN)

(73) Assignee: Weixiang HUANG, Ganzhou (CN)

(21) Appl. No.: 18/735,567

(22) Filed: Jun. 6, 2024

(30) Foreign Application Priority Data
Apr. 6, 2023 (CN) 2023103839116

(51) Int. Cl. B26B 19/14; B26B 19/44

(52) U.S. Cl. CPC B26B 19/148; B26B 19/44

(57) ABSTRACT

The present disclosure provides an electric nose hair suction clipper, which includes a cutter head. The cutter head includes a cutter head housing. Each of two ends of the cutter head housing is respectively provided with a through opening. A cavity is provided between the two through openings. The main housing and the cutter head are detachably connected. A top of the main housing is provided with an air inlet to allow the cavity to communicate with the interior of the main housing. The interior of the main housing is provided with a shaft fan, which includes a shaft. A lower end of the shaft is provided with a guide plate with an inward recessed bottom surface, an upper surface of the guide plate is provided with a plurality of guide ribs, and the plurality of guide ribs are arranged at intervals on the guide plate in sequence.

### CROSS-REFERENCE TO RELATED APPLICATIONS

This application claims priority benefits to Chinese Patent Application No. 2023103839116, filed Apr. 6, 2023, the contents of which are incorporated herein by reference.

### TECHNICAL FIELD

The present disclosure relates to the technical field of nose hair devices, and in particular, to an electric nose hair suction clipper.

### BACKGROUND

Too long nose hair in a human's nasal cavity will not only affect the human's appearance, but also easily cause itching and sneezing inside the nasal cavity. A general manual nose hair suction clipper may be used to trim the nose hair that stretch out of the nasal cavity. However, an user cannot observe the inside of the nasal cavity, causing the user not able to trim the nose hair inside and is prone to danger. A nose hair cutter of an electric nose hair suction clipper may be extended into the nasal cavity. An inner blade and an outer blade of the nose hair suction clipper may be cooperated to trim the nose hair which is inserted into the nose hair cutter. However, an ordinary electric nose hair suction clipper does not have the function of adsorbing the debris of the nose hair. Nose hair debris may fall into the nasal cavity or be adsorbed on the blade, affecting user experience.

### SUMMARY

An electric nose hair suction clipper includes a cutter head, a main housing and a shaft fan. The cutter head includes a cutter head housing, each of two ends of the cutter head housing is provided with an through opening, and a cavity is provided between the two through openings. The cutter head is connected to the main housing, a top of the main housing is provided with an air inlet, and the cavity communicates with an interior of the main housing through the air inlet. The shaft fan is arranged inside the main housing. The shaft fan includes a shaft, a lower end of the shaft is provided with a guide plate with an inward recessed bottom surface, a plurality of flow guide ribs are fixedly arranged on an upper surface of the guide plate, and the plurality of flow guide ribs are arranged at intervals on the guide plate.

### BRIEF DESCRIPTION OF DRAWINGS

The description and drawings are provided for a better understanding of the present disclosure. The illustrative embodiments and their descriptions are used to explain but do not constitute an improper limitation of the present disclosure.

FIG. 1 is a schematic structural view of an embodiment.

FIG. 2 is a schematic exploded structural view according to an embodiment.

FIG. 3 is a schematic structural view of a shaft fan according to an embodiment.

FIG. 4 is a schematic top structural view of a shaft fan according to an embodiment.

FIG. 5 is a schematic structural view of a bottom of an inner cutting knife according to an embodiment.

FIG. 6 is a schematic cross-sectional structural view of a shaft fan according to an embodiment.

FIG. 7 is a schematic structural view of a cutter head and a main housing separated with each other according to an embodiment.

FIG. 8 is a schematic cross-sectional structural view of an embodiment.

Reference signs: 1—cutter head; 11—cutter head housing; 110—cavity; 12—blade cover; 13—inner cutting knife; 131—mounting hole; 2—main housing; 20—fastener; 21—first housing; 211—female buckle; 22—second housing; 221—male buckle; 23—air inlet; 24—air outlet; 3—shaft fan; 31—shaft; 32—motor connection hole; 33—guide plate; 34—flow guide rib; 4—motor; 5—line compartment; 6—charging interface; 7—filter; 71—through hole.

### DETAILED DESCRIPTION OF THE EMBODIMENTS

The present disclosure will be described in detail below with reference to the accompanying drawings and embodiments. Each example is provided to explain but not as a limitation of the present disclosure. It will be apparent to those skilled in the art that modifications and variations may be made without departing from the scope or spirit of the present disclosure. For example, features shown or described as part of one embodiment may be used on another embodiment, to yield yet another embodiment. It is therefore intended that the present disclosure cover such modifications and variations as come within the scope of the appended claims and their equivalents.

In the description of the present disclosure, orientations or positional relationships indicated by terms “longitudinal”, “transversal”, “upper”, “lower”, “front”, “back”, “left”, “right”, “vertical”, “horizontal”, “top”, “bottom”, etc., are based on the orientations or positional relationships shown in the drawings. They are only for the convenience of describing and do not require that the present disclosure must be constructed and operated in a specific orientation. Therefore, it cannot be understood as limitations on the present disclosure. Terms “connected”, “connecting” and “arranged” used in the present disclosure should be understood in a broad sense. For example, it may be a fixed connection or a detachable connection; it may be a direct connection or an indirect connection through an intermediate component; it may be a wired electrical connection, a radio connection, or a wireless signal connection. For those skilled in the art, the specific meaning of the above terms may be understood according to the specific situation.

One or more examples of the disclosure are illustrated in the accompanying drawings. The detailed description uses numerical and letter signs to refer to features in the drawings. In the drawings and description, reference signs or the like have been used to refer to similar parts of the present disclosure. As used herein, terms “first,” “second,” “third” and the like are used interchangeably to distinguish one component from another and are not intended to denote the position or importance of individual components.

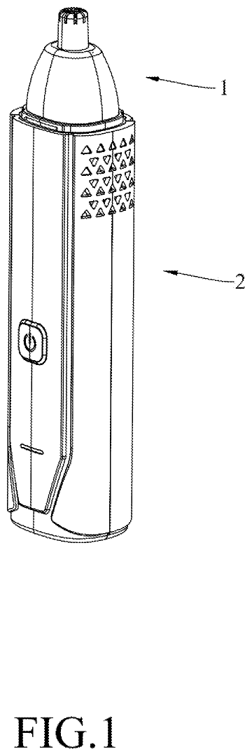

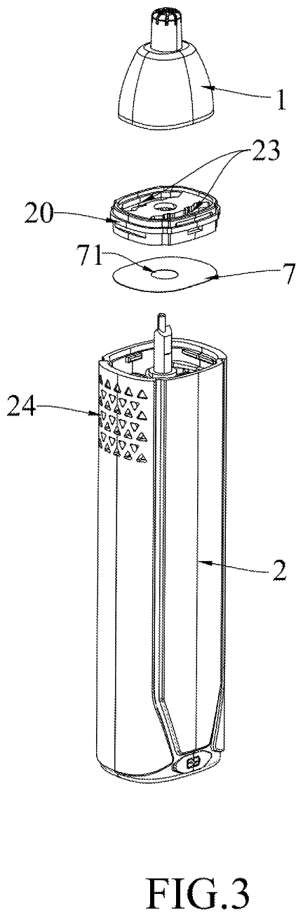

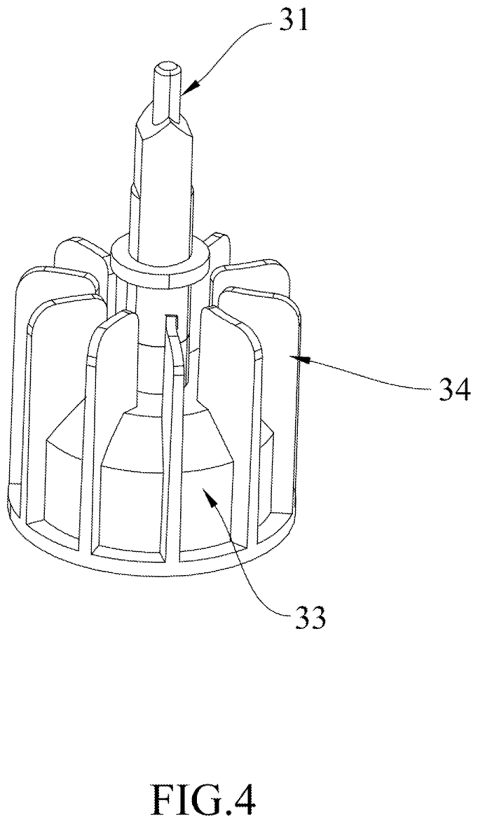

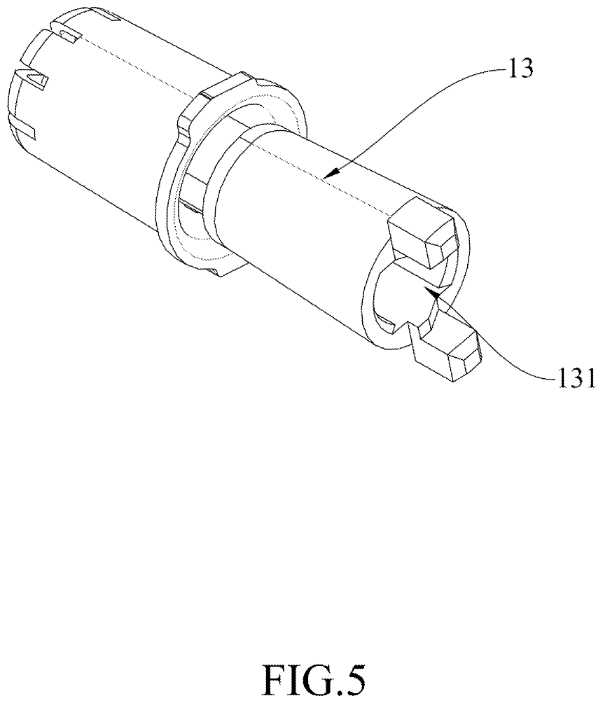

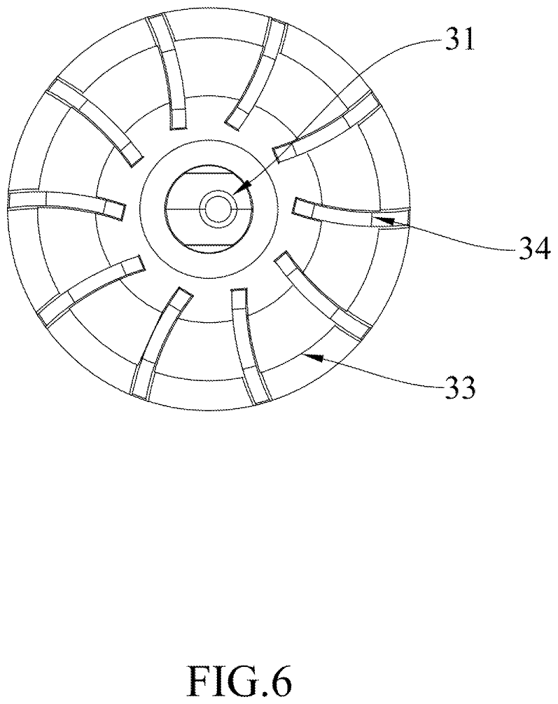

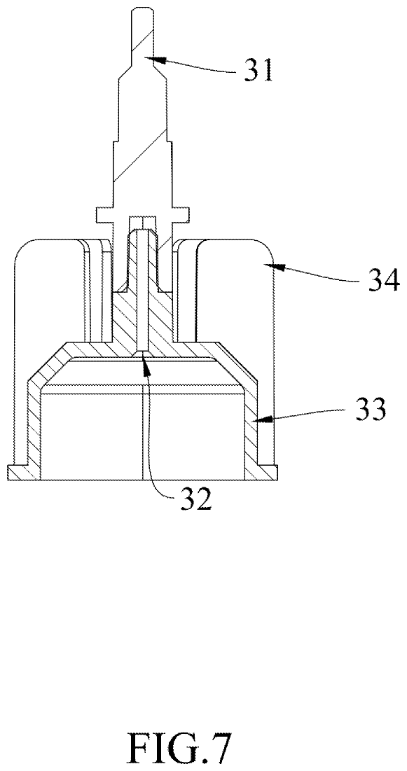

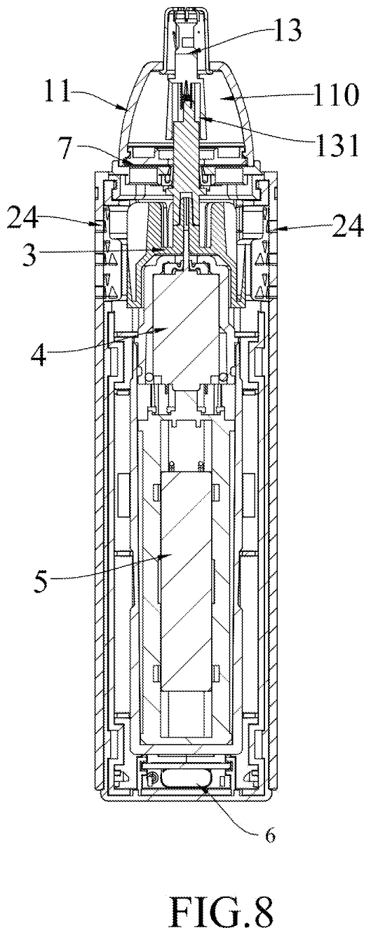

As shown in FIG. 1 to FIG. 8, according to an embodiment of the present disclosure, an electric nose hair suction clipper is provided. The electric nose hair suction clipper includes a cutter head 1 and a main housing 2. The cutter head 1 and the main housing 2 are detachably connected. The cutter head includes a cutter head housing 11. A top and a bottom of the cutter head housing 11 are respectively provided with a through opening. A cavity 110 is provided between the two through openings. A blade cover 12 is arranged at the through opening of the top of the cutter head housing 11. The blade cover 12 is provided with a plurality of slots to facilitate nose hair to extend into the inside of the blade cover 12. An inner cutting knife 13 is arranged inside the blade cover 12, and the inner cutting knife 13 rotates inside the blade cover 12 to cooperate with the blade cover 12, thus cutting off the nose hair extending into the inside of the blade cover 12.

A shaft fan 3 is provided inside the main housing 2. The shaft fan 3 includes a shaft 31. An upper part of the shaft 31 passes through a top of the main housing 2 to connect with the inner cutting knife 13. A cross section of the shaft 31 is in the shape of a running track, and an upper end of the shaft 31 is arranged as a tip to facilitate to be inserted to a bottom of the inner cutting knife 13. The bottom of the inner cutting knife 13 is provided with a mounting hole 131 that matches a cross-sectional shape and a size of the shaft 31, such that the inner cutting knife 13 may be arranged on the upper end of the shaft 31. When the shaft 31 rotates, the inner cutting knife 13 rotates synchronously with the shaft 31. The cross section of the shaft 31 may also be designed in other non-circular shapes, such that when the shaft 31 is inserted into the inner cutting knife 13, the two will not rotate relative to each other. A lower end of the shaft 31 is provided with an motor connection hole 32 for inserting and connecting an output end of a motor 4. There is an interference fit between the motor output end and the motor connection hole 32. The lower end of the shaft 31 is provided with a guide plate 33 with an inward recessed bottom surface. A diameter of a bottom opening of the guide plate 33 is greater than a width of the motor 4, such that when the output end of the motor 4 is inserted into the motor connection hole 32, the upper end of the motor 4 is accommodated inside the guide plate 33. The guide plate 33 and the shaft 31 may be fixedly connected, or the guide plate 33 and the shaft 31 may be integrated into one piece. In the present embodiment, the guide plate 33 and the shaft 31 are two parts fixedly connected, which is easy for manufacturing process.

A plurality of flow guide ribs 34 are vertically disposed on an upper surface of the guide plate 33. The plurality of flow guide ribs 34 are evenly spaced around a circumference of the guide plate 33, and each flow guide rib 34 is deflected at a certain angle in turn relative to its adjacent flow guide rib 34, such that the plurality of guide ribs 34 are spirally distributed on the guide plate 33. Compared with the way of distributing the guide ribs along a radius, a width of a plane surface of the spirally distributed guide ribs 34 is larger, and an air volume driven is greater. Correspondingly, the adsorption capacity of nose hair debris is stronger.

In some embodiments, the lower opening of the guide plate 33 may also be in other shapes, such as a stepped groove shape, which may accommodate the upper end of the motor inside the guide plate 33, and may not only increase the width of the guide rib 34, but also make the arrangement of the internal components more compact.

The main housing 2 includes a first housing 21 and a second housing 22. The first housing 21 and the second housing 22 are arranged oppositely. The first housing 21 is provided with three female buckles 211. The second housing 22 is provided with three male buckles 221, the position of which corresponds to those of the three female buckles 211. Each of the three male buckles 221 matches each of the three female buckles 211. The first housing 21 and the second housing 22 are detachably connected by means of snap-on connection of the male buckles 221 and the female buckles 211. An end of the first housing 21 and an end of the second housing 22 are connected to a fastener 20, and the fastener 20 is detachably connected to the first housing 21 and the second housing 22. The fastener 20 is provided with a shaft through hole. When the fastener 20 is arranged at the end of the connected first housing 21 and second housing 22, the shaft 31 passes through the fastener 20. The fastener 20 is also provided with an air inlet 23 in communication with the interior of the main housing 2. A surface, corresponding to the arrangement position of the guide rib 34 on the shaft fan 3, of the second housing 22 is provided with an air outlet 24 that communicates with the interior of the main housing 2. The air outlet 24 communicates with the air inlet 23. When the shaft fan 3 rotates under the driven of the motor 4, the air outside the main housing 2 is sucked in from the air inlet 23, and flows to the air outlet 24 through the backflow channel between the adjacent guide ribs 34 on the shaft fan 3, thereby forming an adsorption area above the air inlet 23. When the cutter head 1 is arranged on the main housing 2, the shaft fan 3 rotates under the driven of the motor 4 to realize the downward adsorption force of the cutter head 1 from the top.

In some embodiments, the main housing 2 may be divided into two or more than two housings for detachable connection, and the air outlet may be provided on a position of the housing relative to the position of the guide rib 34 on the shaft fan 3, which may realize the air circulation in the main housing 2 and will not be described in detail in the present embodiment.

A line compartment 5 is also arranged inside the main housing 2. The motor 4 and one end of the line compartment 5 is detachably snap-fitted and electrically connected. A circuit board for controlling the motor 4 and a battery for providing electric energy to the motor 4 are arranged inside the line compartment 5. The motor 4 is snap-connected to a top of the line compartment 5 and is electrically connected to the internal circuit board. A bottom of the line compartment 5 is provided with a charging interface 6. The charging interface 6 is electrically connected to the circuit board inside the line compartment 5 and is configured to charge the battery. Correspondingly, the bottom of the main housing 2 is provided with an opening corresponding to the position of the charging interface 6 for accessing a power cord.

In order to reduce the possibility of the nose hair debris being adsorbed into the circuit inside the main housing 2, a filter 7 is provided on the fastener 20 on the top of the main housing 2. The filter 7 is fixed inside the fastener 20, and a through hole 71 is defined in a center of a surface of the filter 7. A size of the through hole 71 matches an outer diameter of the shaft 31, such that the shaft 31 may pass through the through hole 71, and the filter 7 does not follow the rotation of the shaft 31 when the shaft 31 rotates. When an user's nose hair penetrates into the interior of the blade cover 12, it is cut into debris by the inner cutting knife 13. The hair debris is attracted downward by the shaft fan 3 and onto the filter 7, reducing the possibility of the debris entering the shaft fan 3 and the interior of the main housing 2. In addition, the user may remove the cutter head 1 to clean the nose hair debris after use. If the filter 7 is dirty, the user may also remove the fastener 20 and remove the filter 7 for cleaning or replacing.

In some embodiments, as shown in FIG. 1 to FIG. 8, an electric nose hair suction clipper is provided. The electric nose hair suction clipper includes a cutter head 1, a main housing 2 and a shaft fan 3. The cutter head 1 and the main housing 2 are detachably connected. The shaft fan is arranged inside the main housing 2. The cutter head includes a cutter head housing 11. A top and a bottom of the cutter head housing 11 are respectively provided with a through opening. A cavity 110 is provided between the two through openings. A blade cover 12 is arranged inside the cutter head housing 11 and an inner cutting knife 13 is arranged inside the blade cover 12. The through opening at the top of the cutter housing 11 allows nose hair to extend into the blade cover 12 and further to be in contact with the inner cutting knife 13. The shaft fan 3 includes a shaft 31. An upper part of the shaft 31 passes through a top of the main housing 2 to connect with the inner cutting knife 13. A top of the main housing 2 is provided with an air inlet 23, and the cavity 110 communicates with an interior of the main housing 2 through the air inlet 23. The inner cutting knife 13 rotates inside the blade cover 12 to cooperate with the blade cover 12, thus cutting off the nose hair extending into the inside of the blade cover 12. The shaft fan 3 rotates to realize the downward adsorption force from the air inlet 23 to the interior of the main housing 2, which facilitate the entering of the nose hair into the blade cover 12, thus improving the cutting efficiency of the nose hair.

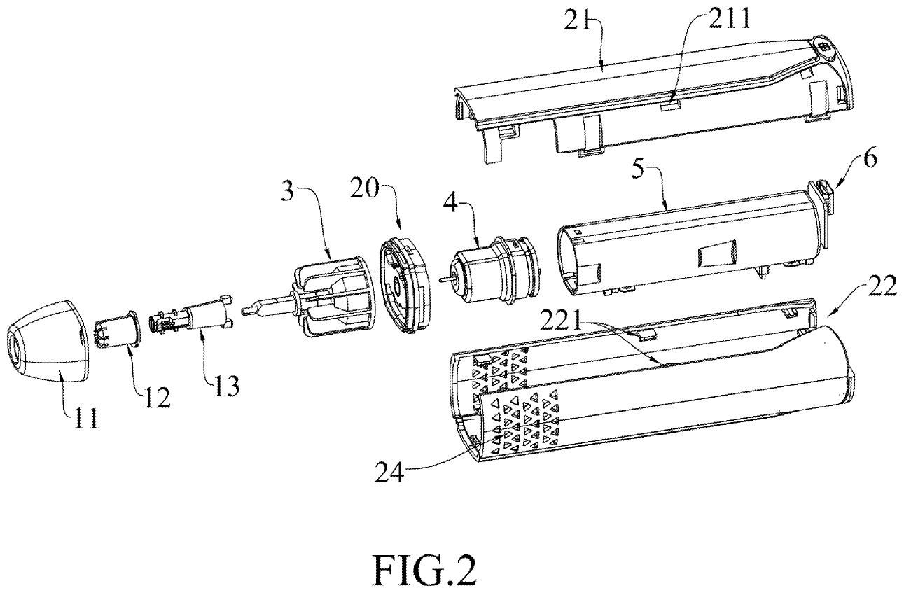

In some embodiments, as shown in FIG. 2, the blade cover 12 is provided with a plurality of slots. For example, the plurality of slots may be evenly distributed along a circumference of the blade cover 12, such that the nose hair may extend from all directions into the blade cover 12.

From the above description, it may be seen that the above-mentioned embodiments of the present disclosure achieve the following technical effects.

1. The shaft fan 3 is arranged inside the main housing. The shaft fan 3 rotates synchronously with the inner cutting knife 13 to cut the nose hair in the nasal cavity and at the same time absorb the nose hair debris downward to reduce the possibility of the debris falling into the nasal cavity and facilitate cleaning.

2. The shaft fan 3 is provided with the bowl-shaped guide plate 33. The plurality of guide ribs 34 are arranged above the guide plate 33. The plurality of guide ribs 34 are evenly spaced in sequence on the guide plate 33, and each guide rib 34 are deflected at the same angle relative to its adjacent guide rib 34 in turn. Compared with the way of distributing the guide ribs along the radius, the spirally distributed guide ribs 34 have a larger surface width and drive a greater air volume. As a result, it has a stronger adsorption capacity for nose hair debris.

3. The filter 7 is provided in the main housing 2. The filter 7 isolates the nose hair debris between the cutter head 1 and the filter 7, reduces the possibility of the nose hair debris entering the interior of the main housing 2 and contaminating the internal circuit.

4. The first housing 21 and the second housing 22 of the main housing 2 are connected through multiple male buckles 221 and female buckles 211, which makes the arrangement more convenient while ensuring stable connection.

Compared with the related art, the electric nose hair suction clipper of the present disclosure may absorb the nose hair debris while cutting the nose hair, and the nose hair debris may be stored in the cutter head, which is convenient for cleaning, and the electric nose hair suction clipper of the present disclosure may improve the debris adsorption capacity and user experience.

The above are only some embodiments and are not intended to limit the present disclosure. For those skilled in the art, the present disclosure may have various modifications and changes. Any modifications, equivalent substitutions, improvements, etc., made within the spirit and principles of the present disclosure shall be included in the protection scope of the present disclosure.

What is claimed is:

1. An electric nose hair suction clipper, comprising:
a cutter head, comprising a cutter head housing, wherein each of two ends of the cutter head housing is provided with an through opening, and a cavity is provided between the two through openings;
a main housing, wherein the cutter head is connected to the main housing, a top of the main housing is provided with an air inlet, and the cavity communicates with an interior of the main housing through the air inlet; and
a shaft fan, arranged inside the main housing; wherein the shaft fan comprises a shaft, a lower end of the shaft is provided with a guide plate with an inward recessed bottom surface, a plurality of flow guide ribs are fixedly arranged on an upper surface of the guide plate, and the plurality of flow guide ribs are arranged at intervals on the guide plate.

2. The electric nose hair suction clipper according to claim 1, wherein each of the flow guide ribs is deflected at a same angle as its adjacent flow guide rib to allow the plurality of the flow guide ribs to be spirally arranged on the guide plate.

3. The electric nose hair suction clipper according to claim 2, wherein an air outlet is provided on a side wall of the main housing, the air outlet is located in a position corresponding to an arrangement position of the guide ribs, and the air outlet is in communication with the air inlet.

4. The electric nose hair suction clipper according to claim 3, wherein a blade cover is arranged at an upper opening of the cutter head housing, an inner cutting knife is arranged inside the blade cover, and an upper part of the shaft passes through a top opening of the main housing to connect with the inner cutting knife.

5. The electric nose hair suction clipper according to claim 4, wherein a cross-section of the shaft is non-circular, and a mounting hole is provided at a bottom of the inner cutting knife, a size and a cross-sectional shape of the mounting hole is consistent with those of the inner cutting knife, and the inner cutting knife is connected to the shaft by means of transmission.

6. The electric nose hair suction clipper according to claim 4, wherein a bottom end of the shaft is provided with a motor connection hole, and an output end of a motor is connected to the shaft with an interference through the motor connecting hole.

7. The electric nose hair suction clipper according to claim 6, wherein a bottom width of the guide plate is greater than a width of the motor, an upper end of the motor is accommodated in a recessed space formed in the bottom of the guide plate, in response to the output end of the motor being inserted into the motor connection hole.

8. The electric nose hair suction clipper according to claim 3, wherein the main housing comprises a first housing and a second housing, the first housing is provided with at least two female buckles, the second housing is provided with at least two male buckles corresponding to and matching a position of the female buckles, the first housing and the second housing are detachably buckled and snapped through the male buckles and the female buckles.

9. The electric nose hair suction clipper according to claim 6, wherein a circuit compartment is arranged inside the main housing, and the motor and the circuit compartment are detachably snap-fitted and electrically connected.

10. The electric nose hair suction clipper according to claim 8, wherein an end of a connected first housing and second housing are detachably connected to a fastener, and a filter is arranged inside the fastener to reduce the possibility of hair debris entering the inside of the main housing.

11. The electric nose hair suction clipper according to claim 10, wherein a through hole is defined in a center of a surface of the filter, a size of the through hole is greater than an outer diameter of the shaft to allow the shaft to pass through the through hole, and the filter does not follow the rotation of the shaft, in response to the rotation of the shaft.

12. An electric nose hair suction clipper, comprising:
a cutter head, comprising a cutter head housing, wherein each of two ends of the cutter head housing is provided with an through opening, and a cavity is provided between the two through openings, a blade cover is arranged inside the cutter head housing, an inner cutting knife is arranged inside the blade cover;
a main housing, wherein the cutter head is connected to the main housing, a top of the main housing is provided with an air inlet, and the cavity communicates with an interior of the main housing through the air inlet; and
a shaft fan, arranged inside the main housing; wherein the shaft fan comprises a shaft; wherein an upper part of the shaft passes through a top of the main housing to connect with the inner cutting knife.

13. The electric nose hair suction clipper according to claim 12, wherein the blade cover is provided with a plurality of slots.

14. The electric nose hair suction clipper according to claim 12, a lower end of the shaft is provided with a guide plate, a plurality of flow guide ribs are fixedly arranged on an upper surface of the guide plate, and the plurality of flow guide ribs are arranged at intervals on the guide plate.

15. The electric nose hair suction clipper according to claim 14, wherein each of the flow guide ribs is deflected at a same angle as its adjacent flow guide rib to allow the plurality of the flow guide ribs to be spirally arranged on the guide plate.

16. The electric nose hair suction clipper according to claim 14, wherein an air outlet is provided on a side wall of the main housing, the air outlet is located in a position corresponding to an arrangement position of the guide ribs, and the air outlet is in communication with the air inlet.

17. The electric nose hair suction clipper according to claim 12, wherein a cross-section of the shaft is non-circular, and a mounting hole is provided at a bottom of the inner cutting knife, a size and a cross-sectional shape of the mounting hole is consistent with those of the inner cutting knife, and the inner cutting knife is connected to the shaft by means of transmission.

18. The electric nose hair suction clipper according to claim 12, wherein a bottom end of the shaft is provided with a motor connection hole, and an output end of a motor is connected to the shaft with an interference through the motor connecting hole.

19. The electric nose hair suction clipper according to claim 12, wherein the main housing comprises a first housing and a second housing, the first housing is provided with at least two female buckles, the second housing is provided with at least two male buckles corresponding to and matching a position of the female buckles, the first housing and the second housing are detachably buckled and snapped through the male buckles and the female buckles; and
an end of a connected first housing and second housing are detachably connected to a fastener, and a filter is arranged inside the fastener to reduce the possibility of hair debris entering the inside of the main housing.

20. The electric nose hair suction clipper according to claim 19, wherein a through hole is defined in a center of a surface of the filter, a size of the through hole is greater than an outer diameter of the shaft to allow the shaft to pass through the through hole, and the filter does not follow the rotation of the shaft, in response to the rotation of the shaft.
